(19) United States
(12) Patent Application Publication
(10) Pub. No.: US 2019/0321831 A1
(43) Pub. Date: Oct. 24, 2019

(54) METHOD AND APPARATUS FOR WASHING PLASTICS MATERIALS

(71) Applicant: PREVIERO N. S.R.L., Lissone (IT)

(72) Inventor: Flavio PREVIERO, Lissone (IT)

(21) Appl. No.: 16/472,257

(22) PCT Filed: Dec. 27, 2017
(86) PCT No.: PCT/EP2017/084646

§ 371 Date: Jun. 21, 2019

(30) Foreign Application Priority Data
Dec. 28, 2016 (IT) 102016000131842

(51) Int. Cl. B03B 5/38; B29B 17/02; B29B 17/04

(52) U.S. Cl. CPC B03B 5/38; B29B 17/02; B29B 2017/0244; B29B 2017/0289; B29B 17/0412

(57) ABSTRACT

Method for washing a plastics material and for separating contaminating substances therefrom comprises the steps of: supplying a first flow of a washing fluid together with the plastics material with contaminants to a washing container in which a stirrer generates a turbulent action to detach mechanically the contaminants adhering to the plastics material, enabling a first fraction of heavier contaminants to precipitate onto a first bottom portion of the container, thus performing a first action of separating contaminants; transferring a second flow: of fluid with floating plastics material from the container to a first separating chamber, in which a second separating action takes place with the precipitation of a second fraction of the contaminants onto a second bottom portion of the first chamber; conveying a third flow of fluid with floating plastics material from the first chamber to a second separating chamber and evacuating by overflowing an outgoing flow of fluid together with the processed plastics material; in the transit froth the first chamber to the second chamber the agglomerates of floating plastics are disaggregated, and to the third flow and to the plastics material a downward propelling action inside the second chamber is imparted to promote a third separating action with precipitation of a third fraction of the contaminants onto a third bottom portion of the second chamber; removing from the second chamber a recirculation flow comprising precipitated fluid and contaminants and sending the recirculation flow to a screen unit that retains the contaminants, returning the washing fluid to the first or second chamber. The apparatus for implementing the aforesaid method is also disclosed.

### CROSS-REFERENCE TO RELATED APPLICATIONS

This application is a § 371 National Stage Entry of International Patent Application No. PCT/EP2017/084646 filed Dec. 27, 2017. Application No. PCT/EP2017/084646 claims priority of IT102016000131842 filed Dec. 28, 2016. The entire content of these applications are incorporated herein by reference.

### BACKGROUND OF THE INVENTION

This invention relates to a method and an apparatus for washing and separating plastics materials—coming from domestic and/or industrial waste that is milled or reduced into small pieces from various types of contaminant. The plastics pieces to be processed can come, for example, from containers, bottles, films and other post-consumption objects, and once they have been decontaminated they are ready for reuse as regenerated material.

The contaminants to be eliminated can comprise earth, sand, gravel, various types of dirt, labels or elements of other material remaining adhering to plastics pieces.

In the field of treatment to recover plastics materials, washing systems are known that provide one or more washing tanks or containers, inside which the material is made to transit with which the contaminant to be eliminated aggregates.

From IT1326462, an apparatus is known that is configured for continuous washing of recovery material previously reduced into pieces, which is subjected to successive washing steps in a plurality of reactors that are serially connected to one another, inside which washing water is made to flow continuously, and a given quantity of recovery material.

Other systems are disclosed in U.S. Pat. No. 4,196,019, EP 0 094 282, U.S. Pat. No. 4,073,661, EP 0 129 518, and EP0359106.

In particular, the object of U.S. Pat. No. 4,196,019 is an apparatus for washing plastics material in pieces of small dimensions, in which the apparatus comprises an elongated tank, which is suitable for being filled up to a preset level with a washing bath, provided with a blade stirrer that extends horizontally just below the upper level of the washing bath, to generate a stirring state; the plastics pieces flow to a horizontal channel from which they are discharged by a rotating drum.

A similar apparatus is disclosed in U.S. Pat. No. 4,073,661: the plastics material in pieces of small dimensions is inserted into a water bath of a washing tank comprising a horizontal stirrer; the pieces of plastics material that float in the tank are removed by being dragged by a screw conveyor, which is positioned partially above the washing bath and along an upwardly oriented discharge channel.

EP 0 094 282 discloses a recovery system comprising a plurality of washing tanks that are serially connected and communicate with one another by labyrinth passages, in which the single washing tanks are provided with normal blade stirrers; the pieces of plastics material that float in the water bath are pushed along a discharge channel by a plurality of rotors that are suitably spaced apart along a discharge channel, and extracted from the bath by a blade wheel.

None of the currently known systems, including those disclosed above, is able to solve a problem disclosed below.

In order to separate the contaminants from the plastics material, the different specific weight thereof is generally exploited. Pieces of plastics material with specific weight that is about the same or less than the washing water are in a floating condition, whereas the contaminants with a specific weight generally greater than that of the water should precipitate to the bottom of the containers or washing tanks.

Unfortunately, in practice, conditions occur that adversely affect this principle of selection by specific weight, greatly reducing the efficiency of the entire separating process.

More precisely, when recycling low-density materials, thus materials with a lower specific weight than that of the washing fluid, a significant volume of product is generated that has to be processed.

in the separating tank, agglomerates of plastics material tend to be generated that act as “rafts” of floating material that affect the separating quality of the heavy materials. Basically, such floating agglomerates, in addition to not allowing thorough washing of the individual pieces of plastics, act as a support for the aggregated contaminants, preventing the precipitation thereof downwards.

Simply adopting blades that are suitable for pushing the material below the water surface to promote sinking of the heavy contaminants is not sufficient inasmuch the agglomerates tend to remain cohesive and compact.

As the commercial value of the recovery material is closely connected to the degree of cleanliness and purity thereof, is thus linked to the percentage of residual contaminants that remain at the end of washing, the great need to overcome the problem disclosed above and thus to obtain a more efficient washing and separating process is evident.

### SUMMARY OF THE INVENTION

One object of the invention is to improve current washing systems for plastics materials.

Another object of the invention is to provide a solution that, in addition to being constructionally and functionally simpler, enables higher levels of parity and decontamination of plastics materials to be achieved.

In particular, one object of the invention is to provide a solution that is able to solve the problem of floating agglomerates of plastics material that prevent thorough washing of the pieces and complete precipitation of the heavier contaminants.

In particular, owing to the conveying unit comprising a disaggregating-propelling arrangement, which in one embodiment comprises a screw conveying device, the problem of floating agglomerates of plastics material is solved.

The agglomerates of plastics are subjected, by the screw conveying device, to an intense disaggregating, opening and singling action, and are forced to descend deep down the tank,

The agglomerates are projected forcibly downwards in the fluid inside the separating tank to be effectively separated from the contaminants. The single parts of plastics material can have air enormous increase in volume that may lead to having greater separation from the contaminants. With the same volume of water used, it is possible to process greater quantities of plastics, with clear economic improvement and a reduction of the environmental impact that arises therefrom.

The action performed by the conveying unit greatly reduces the influence of the phenomenon of undesired floating caused by the microbubbles that adhere to the surfaces of the particles and which in general is normally addressed by chemical additives,

Owing to the drawing and recirculating arrangement that in particular comprises a variable flowrate pump, from the bottom of the tank a recirculation flow is drawn that contributes to regulating the separating efficiency of the material with density that is also very near that of the washing fluid used.

Further, the screen unit enables the contaminants to be retained that are pumped by a removing device and the washing water to be recirculated in the separating tank, thus reducing the consumption of process water, and simplifying the system significantly.

### BRIEF DESCRIPTION OF THE DRAWINGS

These and further features and advantages of the method and of the washing and separating apparatus will be clearer from the following description, with reference to the drawings, in which:

FIGS. 1 and 2 are two different views of a washing and separating apparatus according to the present invention;

FIG. 3 is a longitudinal section according to line III-III of FIG. 2;

FIG. 4 is another longitudinal section, in a perspective view, according to line IV-IV of FIG. 2;

FIG. 5 shows an enlarged detail of FIG. 4;

FIG. 6 is a top view of the apparatus according to the invention;

FIG. 7 is a block flow diagram relating to the washing and separating method according to the invention.

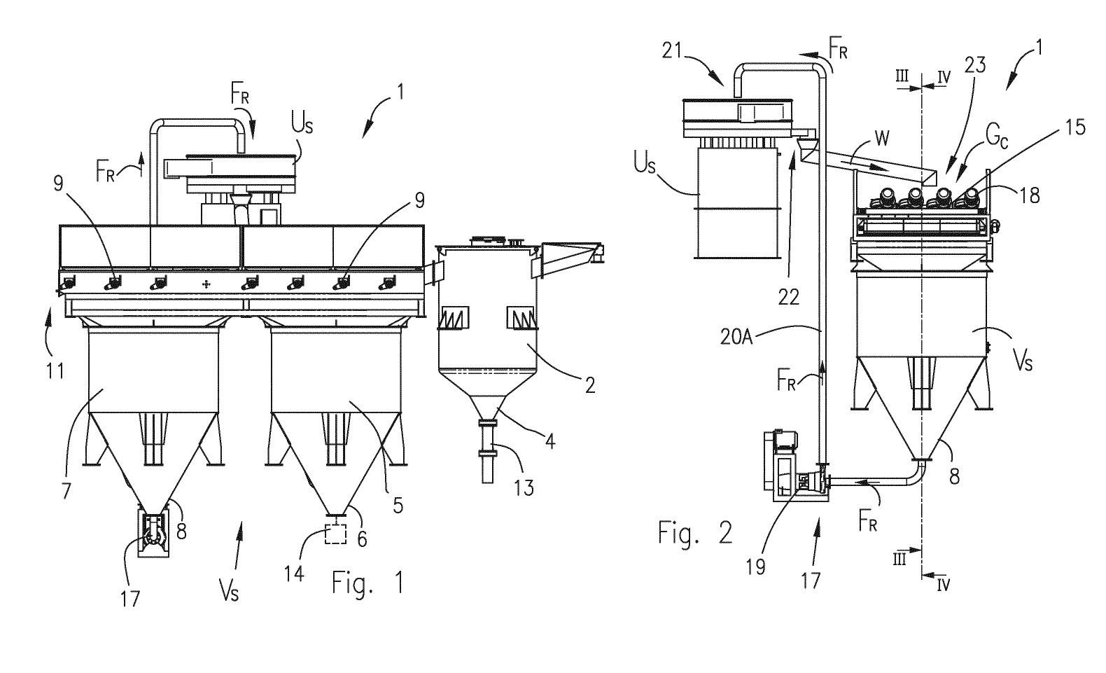

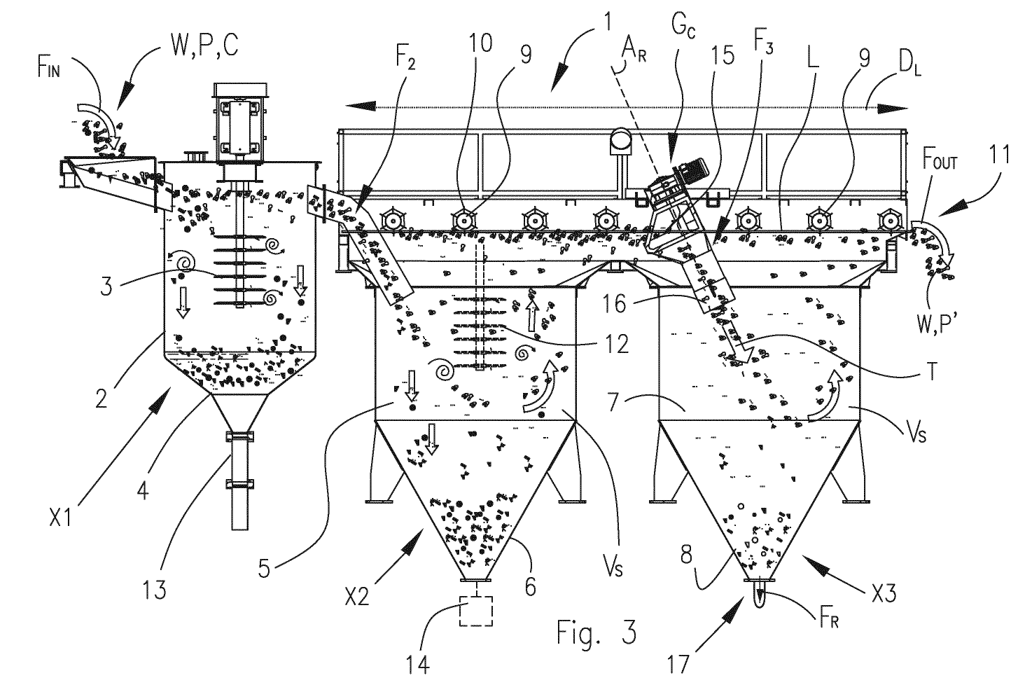

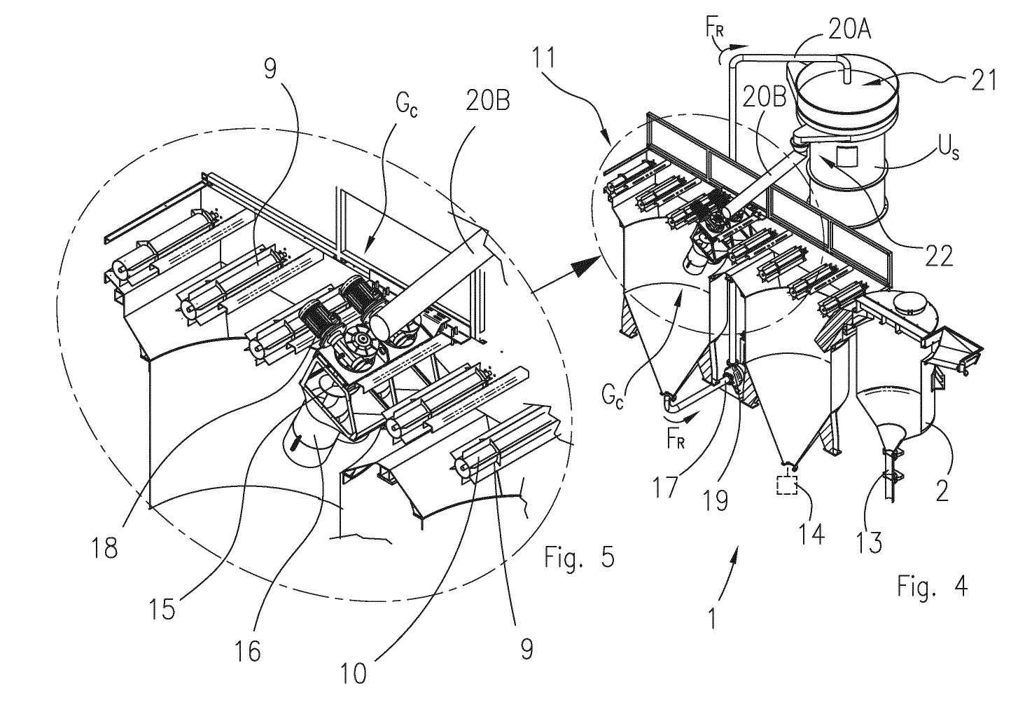

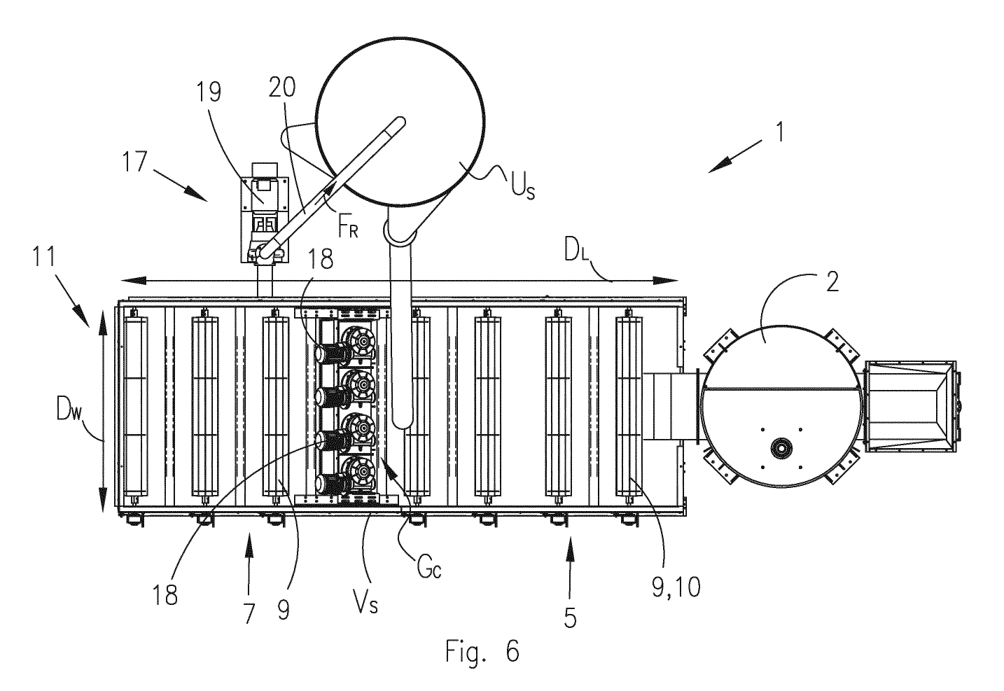

### DETAILED DESCRIPTION OF THE INVENTION

With reference to the attached figures, an apparatus 1 is disclosed below for washing a plastics material P and separating therefrom contaminating substances C.

The apparatus 1 comprises a washing container 2, provided with a stirrer device 3, and suitable for receiving a first flow F_{IN} of a washing fluid W together with the plastics material P containing the contaminants C to be subjected to a first action of separating.

The stirrer device 3 is configured for generating a turbulent stirring action to detach from the plastics material P, by mechanical action, the part of contaminating material C adhering thereto.

The washing container 2 is bounded below by a first bottom portion 4 suitable for receiving a first fraction X1 of the heavier contaminants C.

The washing container 2 is provided below with a removing device 13 of valve or pump type acting to remove periodically the first fraction X1 of the contaminants C that settles on the first bottom portion 4.

The apparatus 1 comprises, downstream of the washing container 2, a separating tank V_{S} comprising a first chamber 5 and a second chamber 7 placed in succession one after the other.

The first chamber 5 is shaped for receiving by overflowing a second flow F2 of washing fluid W with floating plastics material P coming from the washing container 2 to be subjected to a second separating action.

The first chamber 5 can be provided internally with a further stirrer device 12 arranged for generating a turbulent action for detaching mechanically possible further contaminants C adhering to the pieces of plastics material P.

The first separating chamber 5 comprises below a second bottom portion 6 suitable for receiving a second fraction X2 of precipitating contaminants C.

The first separating chamber 5 can be provided with a respective removing device 14 of valve or pump type suitable for drawing periodically the second fraction X2 of contaminants C from the aforesaid second bottom portion 6.

The second chamber 7 is shaped for receiving a third flow F3 of washing fluid W with floating plastics material P coming from the first chamber 5, to be subjected to a third separating action.

On the second chamber 7 an outlet port 11 is obtained through which an outgoing flow F_{OUT} of washing fluid W with processed plastics material P′ is evacuated by overflowing.

The apparatus 1 is provided with a rotatable arrangement 9 configured for facilitating the advancement of the plastics material P in a floating condition from the first chamber 5 to the second chamber 7 and from the second chamber 7 to the outlet port 11.

The rotatable arrangement in particular comprises a plurality of roller or drum elements 9 with a horizontal axis, arranged transversely to the advancement path of the floating plastics material P.

The roller elements 9 are distributed evenly along the longitudinal dimension D_{L} of the separating tank V_{S}.

The roller elements 9 comprise a plurality of baffles 10 that, in rotation, penetrates slightly below the free surface L to push the floating plastics material P along the advancement path.

The apparatus 1 is provided with a conveying unit G_{C} arranged for advancing the third flow F3 from the first chamber 5 to the second chamber 7.

The conveying unit G_{C} comprises a disaggregating-propelling arrangement 15 configured for disaggregating the floating agglomerates of plastics material P and for pushing the third flow F3 by force downwards inside the second chamber 7 to separate farther a third fraction X3 of the contaminants C from the plastics material P.

The disaggregating-propelling arrangement, more precisely, comprises a plurality of screw conveying units 15 that are rotatable around rotation axes A_{R} that are tilted with respect to an axis that is vertical and drivable by respective motors 18.

The screw conveying units 15 are contained in respective conduits 16 that protrude inside the second chamber 7.

The screw conveying units 15 and the respective conduits 16 are distributed along an entire width dimension D_{W} of the separating tank V_{S}, so as to define, astride the first chamber 5 and the second chamber 7, an obligatory transit front for the third flow F3 of water and plastics material P.

The apparatus 1 comprises a drawing and recirculating arrangement 17 suitable for drawing, below the separating tank V_{S}, a recirculation flow F_{R} comprising washing fluid W and precipitated contaminants C, and a screen unit U_{S} suitable for receiving the aforesaid recirculation flow F_{R} to retain the contaminants C thereof and return the washing fluid W to the separating tank V_{S}.

The drawing and recirculating arrangement 17 comprises a variable flowrate pump 19 and a:recirculation circuit 20 that extends from a bottom zone of the separating tank V_{S} to an upstream zone 21 placed above the screen unit U_{S}, and from a downstream zone 22 of the screen unit U_{S} to a summit zone 23 placed above the separating tank V_{S}.

In particular, the recirculation circuit 20 comprises a first conduit 20A that extends from the third bottom portion 8 to the upstream zone 21, and a return conduit 20B that protrudes from the downstream zone 22 of the screen unit U_{S} to the aforesaid summit zone 23.

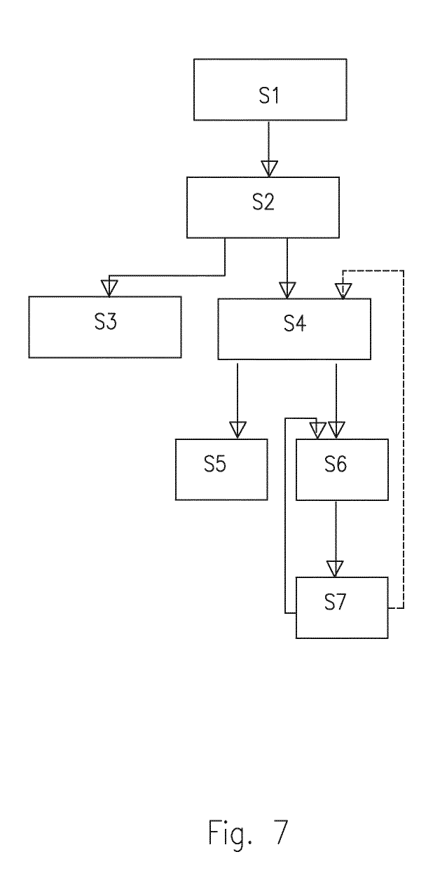

With the help of the block diagram of FIG. 7, the washing and separating method according to the invention is disclosed, which is actuated by the apparatus 1 that has just been disclosed.

The plastics material P coming from pre-washing and milling of post-consumption plastics waste, which waste is reduced into small pieces (dimensions from a few mm to a few cm) and containing contaminants C, is loaded together with an incoming flow F_{IN} of washing fluid W, such as water with possible additives, inside the washing container 2 (block S1).

Inside the container 2 there is a first separation (block S2), with precipitation of a first fraction X1 of the contaminants C onto the first bottom portion 4 and transfer of a second flow F2 of water W with plastics material to the first separating chamber 5 (block S4).

The first fraction X1 of the contaminants C deposited on the first bottom portion 4 is evacuated periodically by the removing device 13 of valve or pump type (block S3).

During the process, the roller or drum elements 9 are driven, at a rotation speed that is suitable for advancing the plastics material P, maintaining the plastics material P inside the washing container 2 and inside the separating tank VS for the time that is necessary to obtain the desired degree of purity and decontamination.

The incoming F_{IN} and outgoing F_{OUT} flows are adjusted according to the required degree of “refresh” for the washing fluid W.

The right degree of “refresh” is determined by taking account of both the degree of purity and decontamination aimed for and the specific economy needs to be met.

The speed of the roller or drum elements 9 can be adjusted according to the incoming/outgoing fluid flowrates and the degree of purity that it is desired to obtain for the processed plastics material P.

In the case of operation with a high degree of change of the washing fluid W, thus with high inlet and outlet flowrates and strong overflow effect, the roller elements 9 act to slow the flow of outgoing plastics material with respect to the outgoing flow of fluid W, contrasting the dragging hydrodynamic action of the fluid and gradually enabling the plastics material P to advance from one chamber to the next chamber to the outlet port 11.

In the case of operation with reduced inlet and outlet flowrates of the fluid W, and thus less overflow and dragging effect, the roller elements 9 perform a dragging effect that helps the plastics material to advance to the outlet port 11.

Inside the first chamber 5, a second fraction X2 of the contaminants precipitates that can be periodically eliminated by the removing device 13 of valve or pump type (block S5).

The plastics material P washed further is transferred (block S6) from the first chamber 5 to the second chamber 6 by the conveying unit Ge disclosed above. The screw conveying units 15, which is rotatable at rotation speeds that are settable from about 100 rpm to about 150 rpm, on the basis of specific process needs and of the features of the material to be processed, act to break up the floating agglomerates of plastics material that inevitably tend to form during the process.

The blocks of floating plastics material are vigorously disaggregated and opened up, and are propelled with force to a depth in the second chamber 7, facilitating the depositing of the contaminants C on the bottom whereas the plastics material with a lesser specific weight rise to the surface to be then evacuated by overflowing from the outlet port 11.

The agglomerates of floating plastics material, owing to the intense action of the screw conveying units 15, are reduced into single pieces (so-called “flakes” or “chips”) which can benefit from:a larger contact surface with the washing fluid, with advantages from the point of view of the degree of cleanliness that is achievable. Naturally, this enables greater quantities of plastics material P to be processed with the same quantity of water used, or vice versa, it is possible to reduce the quantity of water necessary for processing appropriately a certain volume of plastics material P. In all cases, the resulting economic improvement is evident,

The block S7 shows the washing fluid W drawing, filtering and recirculating step,

The variable flowrate pump 19 draws from the bottom of the separating tank (in this case from the third bottom portion 8 of the second separating chamber 7) the recirculating flow F_{R}, contributing to regulating the separating efficiency of the material with density that is also very near that of the washing fluid used.

The recirculating flow F_{R}, containing the third fraction X3 of the contaminants, is sent to the screen unit U_{S}, which is made to vibrate.

The screen unit U_{S} retains the contaminants C whereas the filtered fluid W is returned, by the return conduit 20B, inside the separating tank VS.

Owing to this configuration that ensures a constant elimination of the contaminants C from the washing bath, thus maintaining the quality of the washing fluid W high, the water consumption necessary for the washing process is reduced significantly.

From what has been disclosed and shown in the drawings, it is clear that the method and the washing and separating apparatus according to the invention achieve the set objects successfully.

The method and the apparatus disclosed above enable high levels of purity to be easily obtained in the recovery plastics material in reduced process time, owing to the immediate continuous removal of the contaminants C from the washing container 2 and from the chambers 5 and 7 of the separating tank V_{S}.

Owing to the fragmentation of the floating “rafts” of plastics material P performed by the screw conveying units 15, there is a significant increase in the efficacy of opening, washing and separation of the single pieces of plastics material P from the contaminants.

Propelling water and plastics material downwards promotes depositing of the contaminants C on the bottom of the tank V_{S}, whereas the pumping action of the pump 19, combined synergically with the filtering action of the screen unit U_{S}, ensures constant and continuous removal of the contaminants C, maintaining the washing bath in excellent operating conditions.

The objects are thus achieved of providing a solution that is functionally and constructively simple but is able to reduce general process costs and ensure great efficiency in separating contaminants from plastics materials to be recycled.

It is understood that what has been said and shown with reference to the attached drawings has been given merely by way of illustration of the general features of the method and of the washing and separating apparatus; thus other modifications or variations can be made to the method, to the entire apparatus, or parts thereof, whilst remaining within the context of the claims. In particular, the geometric conformation, dimensions, position and materials that make up one or several parts of the washing apparatus can be selected and/or optimized suitably on the basis of specific operating needs and materials to be processed.

1. Method for washing a plastics material and for separating contaminating substances therefrom, comprising the steps of:
a. supplying a first flow of a washing fluid together with the plastics material containing the contaminants in a washing container in which a stirrer device is in movement to generate a turbulent stirring action intended to detach from the plastics material, through mechanical action, the part of contaminating material adhering thereto, enabling a first fraction of heavier contaminants to precipitate onto a first bottom portion of said washing container, thus performing a first action of separating contaminants,
b. transferring by overflow a second flow of washing fluid with floating plastics material from the washing container to a first chamber of a separating tank, in which a second separating action occurs with the precipitation of a second fraction of contaminants to a second bottom portion of said first chamber,
c. conveying a third flow of washing fluid with floating plastics material from said first chamber to a second chamber of said separating tank and evacuating by overflow an outgoing flow of washing fluid together with the processed plastics material, in which in the transit from said first chamber to said second chamber there is provided
d. disaggregating the floating agglomerates of plastics material (and imparting to said third flow and to the plastics material a downward propelling action inside said second chamber to promote a third separating action with precipitation of a third fraction roof contaminants onto a third bottom portion of said second chamber,
e. removing, from below said separating tank, a recirculation flow comprising washing fluid and precipitated contaminants end sending said recirculation flow to a separating screen unit to retain said contaminants and return the washing fluid to said separating tank.

2. Method according to claim 1, wherein the advancement of the plastics material in a floating condition is facilitated by a horizontal axis rotating arrangement, provided with baffles placed near the free surface, which by rotating pushes the plastics material from said first chamber to said second chamber and from said second chamber to are outlet port by overflowing.

3. Method according to claim 1, wherein inside said first chamber of the separating tank, a further turbulent stirring step is provided by a further stirrer device to detach mechanically any further contaminants adhering to the pieces of plastics material.

4. Method according to claim 1, wherein the floating agglomerates of plastics material are disaggregated and are pushed together with washing fluid to the inside of said second chamber by rotating a screw conveying device having rotation axes that are tilted with respect to a vertical axis, said screw conveyor device being contained in respective conduits that protrude inside said second chamber.

5. Method according to claim 4, wherein said screw conveyor device and said conduits are distributed along the entire width dimension of said separating tank to define, astride said first chamber and said second chamber, an obligatory transit front for a third flow.

6. Method according to claim 1, wherein said recirculation flow is pumped from the bottom of said separating tank to be sent to said screen unit which is vibrated to retain and remove said contaminants and send the washing fluid into said separating tank.

7. Method according to claim 6 wherein said recirculation flow is removed from said third bottom portion a said second chamber, and the washing fluid filtered by said screen unit is returned from above to said second chamber or to said first chamber of said separating tank.

8. Method according to claim 1, wherein, by a first removing device of valve or pump type, said first fraction of contaminants is periodically removed from said first bottom portion, and wherein said second fraction of contaminants is periodically removed from said second bottom portion by a second removing device of valve or pump type.

9. Method according to claim 1, wherein said plastics material has a specific weight that is about the same as or less than the specific weight of said washing fluid.

10. Apparatus for washing a plastics material and for separating contaminating substances therefrom, comprising:
a washing container provided with as stirrer device and suitable for receiving a first flow of a washing fluid together with the plastics material containing the contaminants to be subjected to a first separating action, said stirrer device being configured for generating a turbulent stirring action to detach from the plastics material, through mechanical action, the part of contaminating material adhering thereto, said washing container being bounded below by a first bottom portion that is suitable for receiving a first fraction of heavier contaminants,
a separating tank comprising a first chamber and a second chamber placed in succession,
said first chamber being shaped to receive by overflowing a second flow of washing fluid with floating plastics material coming from said washing container to be subjected to a second separating action, and comprising a second bottom portion that is suitable for receiving a second fraction of contaminants,
said second chamber being shaped for receiving a third flow of washing fluid with floating plastics material, coming from said first chamber, to be subjected to a third separating action, and provided with an outlet port to evacuate by overflowing an outgoing flow of washing fluid with processed plastics material,
for said third flow, comprising a disaggregating-propelling arrangement configured for disaggregating the floating agglomerates of plastics material and for forcibly pushing, downwards inside said second chamber, said third flow to separate further from the plastics material a third fraction of contaminants,
a drawing and recirculating arrangement suitable for drawing from said separating tank, a recirculating flow comprising washing fluid and precipitated contaminants,
a screen unit that is suitable for receiving said recirculating flow to retain the contaminants and is configured for returning the washing fluid to said separating tank.

11. Apparatus according to claim 10, wherein said disaggregating-propelling arrangement comprises a screw conveyor device that is rotatable around rotation axes that are tilted with respect to a vertical axis, said screw conveyor device being contained in a conduit arrangement that protrude inside said second chamber.

12. Apparatus according to claim 11, wherein said screw conveyor device comprises a plurality of screw conveyor units drivable by motors and contained in respective conduits, said screw conveyor units and said respective conduits being distributed along an entire width dimension of said separating tank to define, astride said first chamber and said second chamber, an obligatory transit front for a third flow.

13. Apparatus according to claim 10, wherein said drawing and recirculation arrangement comprises a variable flowrate pump, and a recirculation circuit that extends from a bottom zone of said separating tank to an upstream zone placed above said screen unit, and from a downstream zone of said screen unit to a summit zone placed above said separating tank.

14. Apparatus according to claim 13, wherein said recirculation circuit comprises a first conduit that extends from said third bottom portion to said upstream zone, and a return conduit that protrudes from said downstream zone of said screen unit to said summit zone.

15. Apparatus according to claim 10, further comprising a rotatable arrangement having a horizontal axis, provided with baffles placed near the free surface and configured for facilitating the advancement of the plastics material in a floating condition from said first chamber to said second chamber and from said second chamber to an outlet port by overflowing.

16. Apparatus according to claim 15, wherein said rotatable arrangement comprise a plurality of roller or drum elements arranged transversely to the advancement path of the floating plastics material, and distributed evenly along the longitudinal dimension of said separating tank.

17. Apparatus according to claim 10, wherein inside said first chamber of the separating tank there is provided a further stirrer device for generating a turbulent action to detach mechanically possible further contaminants adhering to the pieces of plastics material.

18. Apparatus according to claim 10, further comprising a first removing device of valve or pump type placed under said first bottom portion to remove periodically said first fraction of contaminants, and a second removing device of valve or pump type, placed under said second bottom portion to remove periodically said second fraction of contaminants.
